(19) United States
(12) Patent Application Publication
(10) Pub. No.: US 2023/0128465 A1
(43) Pub. Date: Apr. 27, 2023

(54) SYSTEM FOR ENHANCED EXPOSURE DETECTION IN DIGITAL CHANNELS

(71) Applicant: BANK OF AMERICA CORPORATION, Charlotte, NC (US)

(72) Inventors: Raghu Karthic Suthan Krishnamurthy, Tamil Nadu (IN); Amit Mishra, Chennai (IN); Aishwarya Ramamoorthi, Erode (IN); Kadekoppa Kiran Rohithakshappa, Waxhaw, NC (US)

(73) Assignee: BANK OF AMERICA CORPORATION, Charlotte, NC (US)

(21) Appl. No.: 17/512,043

(22) Filed: Oct. 27, 2021

(51) Int. Cl. G06F 9/50; G06F 9/48; G06F 21/31

(52) U.S. Cl. CPC G06F 9/5038; G06F 9/4806; G06F 21/31

(57) ABSTRACT

Systems, computer program products, and methods are described herein for enhanced exposure detection framework in digital channels. The present invention is configured to receive, from a user input device and via a communication channel, a request to execute a resource transfer; extract a functional workflow associated with the resource transfer; initiate a rule modelling engine on the functional workflow associated with the resource transfer; crawl, using the rule modelling engine, a dynamic rule repository to determine a predetermined set of rules for the functional workflow; retrieve, from a dynamic rule repository, the predetermined set of rules; implement the predetermined set of rules on the one or more functions associated with the functional workflow; determine that the functional workflow meets one or more requirements of the predetermined set of rules; and authorize the request to execute the resource transfer.

### FIELD OF THE INVENTION

The present invention embraces a system for enhanced exposure detection framework in digital channels.

### BACKGROUND

Exposure mitigation planning is the process of developing options and actions to enhance engagement with the front line and reduce exposure to project objectives. There is a need for a system for intelligent rule modelling for exposure detection dynamically in runtime.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for enhanced exposure detection framework in digital channels is presented. The system comprising: at least one non-transitory storage device; and at least one processing device coupled to the at least one non-transitory storage device, wherein the at least one processing device is configured to: receive, from a user input device and via a communication channel, a request to execute a resource transfer; extract a functional workflow associated with the resource transfer, wherein the functional workflow comprises one or more functions; initiate a rule modelling engine on the functional workflow associated with the resource transfer; crawl, using the rule modelling engine, a dynamic rule repository to determine a predetermined set of rules for the functional workflow; retrieve, from a dynamic rule repository, the predetermined set of rules; implement the predetermined set of rules on the one or more functions associated with the functional workflow; determine that the functional workflow meets one or more requirements of the predetermined set of rules; and authorize the request to execute the resource transfer based on determining that the functional workflow meets the one or more requirements of the predetermined set of rules.

In some embodiments, the at least one processing device is further configured to: initiate an authentication protocol to determine an authorization level of the user in response to receiving the request; determine that the authorization level of the user meets one or more authentication requirements associated with executing the resource transfer; and extract the functional workflow associated with the resource transfer in response to determining that the authorization level of the user meets the one or more authentication requirements associated with executing the resource transfer.

In some embodiments, initiating the authentication protocol further comprises: transmitting, via the user input device, an authentication request; receiving, via the user input device, one or more authentication credentials from the user; and determining the authorization level of the user based on at least the one or more authentication credentials.

In some embodiments, the at least one processing device is configured to: retrieve a priority level associated with each rule in the predetermined set of rules; and implement the predetermined set of rules on the one or more functions associated with the functional workflow in a decreasing order of priority level.

In some embodiments, the at least one processing device is further configured to: determine that the functional workflow does not meet the one or more requirements of the predetermined set of rules; and deny the request to execute the resource transfer based on determining that the functional workflow does not meet the one or more requirements of the predetermined set of rules.

In some embodiments, the at least one processing device is further configured to: determine a likelihood of exposure for the resource transfer based on at least implementing the predetermined set of rules on the one or more functions associated with the functional workflow; determine whether the likelihood of exposure for the resource transfer is lesser than a predetermined threshold; and authorize the request to execute the resource transfer based on at least determining that the likelihood of exposure for the resource transfer is lesser than the predetermined threshold.

In some embodiments, the at least one processing device is further configured to: deny the request to execute the resource transfer based on at least determining that the likelihood of exposure for the resource transfer is greater than the predetermined threshold.

In some embodiments, the at least one processing device is further configured to: generate a resource transfer authentication event based on at least determining that the functional workflow meets one or more requirements of the predetermined set of rules; and record the resource transfer authentication event in an event log.

In another aspect, a computer program product for enhanced exposure detection framework in digital channels is presented. The computer program product comprising a non-transitory computer-readable medium comprising code causing a first apparatus to: receive, from a user input device and via a communication channel, a request to execute a resource transfer; extract a functional workflow associated with the resource transfer, wherein the functional workflow comprises one or more functions; initiate a rule modelling engine on the functional workflow associated with the resource transfer; crawl, using the rule modelling engine, a dynamic rule repository to determine a predetermined set of rules for the functional workflow; retrieve, from a dynamic rule repository, the predetermined set of rules; implement the predetermined set of rules on the one or more functions associated with the functional workflow; determine that the functional workflow meets one or more requirements of the predetermined set of rules; and authorize the request to execute the resource transfer based on determining that the functional workflow meets the one or more requirements of the predetermined set of rules.

In yet another aspect, a method for enhanced exposure detection framework in digital channels is presented. The method comprising: receiving, from a user input device and via a communication channel, a request to execute a resource transfer; extracting a functional workflow associated with the resource transfer, wherein the functional workflow comprises one or more functions; initiating a rule modelling engine on the functional workflow associated with the resource transfer; crawling, using the rule modelling engine, a dynamic rule repository to determine a predetermined set of rules for the functional workflow; retrieving, from a dynamic rule repository, the predetermined set of rules; implementing the predetermined set of rules on the one or more functions associated with the functional workflow; determining that the functional workflow meets one or more requirements of the predetermined set of rules; and authorizing the request to execute the resource transfer based on determining that the functional workflow meets the one or more requirements of the predetermined set of rules.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 illustrates technical components of a system for enhanced exposure detection framework in digital channels, in accordance with an embodiment of the invention;

FIG. 2 illustrates a process flow for enhanced exposure detection framework in digital channels, in accordance with an embodiment of the invention;

FIG. 3 illustrates a data flow diagram for enhanced exposure detection framework in digital channels, in accordance with an embodiment of the invention; and

FIG. 4 illustrates a process flow for intelligent rule modelling for exposure detection.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein.

As used herein, a “user interface” may be any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. An engine may be self-contained, but externally-controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some embodiments, an engine may be configured to retrieve resources created in other computer programs, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, and/or one or more devices, nodes, clusters, or systems within the system environment described herein. For example, an interaction may refer to a transfer of data between devices, an accessing of stored data by one or more nodes of a computing cluster, a transmission of a requested task, or the like.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this invention, a resource is typically stored in a resource repository - a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user’s resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “machine learning algorithms” may refer to programs (math and logic) that are configured to self-adjust and perform better as they are exposed to more data. To this extent, machine learning algorithms are capable of adjusting their own parameters, given feedback on previous performance in making prediction about a dataset. Machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naive Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or any suitable form of machine learning algorithm.

As used herein, “machine learning model” may refer to a mathematical model generated by machine learning algorithms based on sample data, known as training data, to make predictions or decisions without being explicitly programmed to do so. The machine learning model represents what was learned by the machine learning algorithm and represents the rules, numbers, and any other algorithm-specific data structures required to for classification.

The present invention discloses an exposure detection engine that is configured to implement a predetermined set of rules to determine whether a resource transfer initiated by a user has any underlying exposure. While traditional exposure detection systems focus on whether the user is authorized to initiate a resource transfer, the present invention, in addition, details an exposure detection engine that is configured to authenticate, in real-time, the authenticity of the resource transfer in focus. Each resource transfer may have a specific functional workflow, which defines the repeatable pattern of activity for that resource transfer. The system may be configured to identify the functional workflow from the resource transfer to determine an applicable set of rules that will be used to test its authenticity. These rules may be designed specifically for the resource transfer using existing rules stored in a dynamic rule repository. Once the functional workflow is identified, the system may then retrieve the applicable rules for the functional workflow for implementation. Each rule may be designed to test specific functionalities in the (functional) stack. If the functionalities meet the requirements of their corresponding rules, the likelihood of exposure for the resource transfer may be low and the transaction may be subsequently authorized. On the other hand, if the functionalities do not meet the requirements of their corresponding rules, the likelihood of exposure (based on a predefined threshold) for the resource transfer may be high and the transaction may be denied. Any functionality that does not meet its corresponding rule is recorded and the proper administrator is notified.

Furthermore, the present invention discloses a rule modelling engine that is configured to dynamically generate a set of rules for each resource transfer based on its functional workflow. The functional workflow may include specific functionalities organized in the form of a stack. Verifying the authenticity of the transaction requires verifying the authenticity of each functionality. Typically, each functional workflow may have an applicable set of rules that has been previously generated and stored in the dynamic rule repository. When the exposure detection engine identifies the functional workflow of the resource transfer, it retrieves the corresponding set of rules from the dynamic rule repository for implementation. In cases where the functional workflow does not have an existing set of rules, the system dynamically generates them specifically for the functional workflow using machine learning techniques. First, the system may determine the functional workflow of the resource transfer. If the functional workflow is unavailable, the system may access the log files generated by the resource transfer to extract relevant features that may be used to determine its functional workflow. Each function in the functional workflow may be associated with a type of exposure that is likely to affect that function. Next, the system may implement machine learning algorithms to train a mathematical model using existing set of rules for various functionalities. The functional workflow of the resource transfer is then fed into the mathematical model that then suggests applicable rules for testing the functional workflow of the resource transfer and an order of priority for implementation. During implementation, the rules may be implemented in a decreasing order of priority.

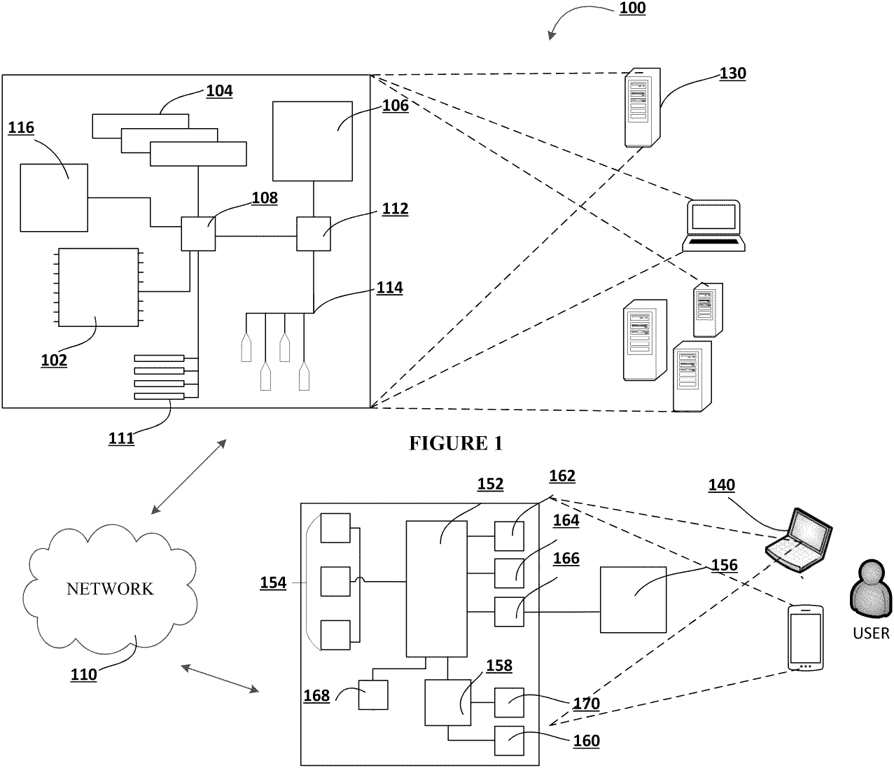

FIG. 1 presents an exemplary block diagram of the system environment for enhanced exposure detection framework in digital channels 100, in accordance with an embodiment of the invention. FIG. 1 provides a unique system that includes specialized servers and system communicably linked across a distributive network of nodes required to perform the functions of the process flows described herein in accordance with embodiments of the present invention.

As illustrated, the system environment 100 includes a network 110, a system 130, and a user input device 140. In some embodiments, the system 130, and the user input device 140 may be used to implement the processes described herein, in accordance with an embodiment of the present invention. In this regard, the system 130 and/or the user input device 140 may include one or more applications stored thereon that are configured to interact with one another to implement any one or more portions of the various user interfaces and/or process flow described herein.

In accordance with embodiments of the invention, the system 130 is intended to represent various forms of digital computers, such as laptops, desktops, video recorders, audio/video player, radio, workstations, servers, wearable devices, Internet-of-things devices, electronic kiosk devices (e.g., automated teller machine devices), blade servers, mainframes, or any combination of the aforementioned. In accordance with embodiments of the invention, the user input device 140 is intended to represent various forms of mobile devices, such as personal digital assistants, cellular telephones, smartphones, augmented reality (AR) devices, virtual reality (VR) devices, extended reality (XR) devices, and other similar computing devices. The components shown here, their connections and relationships, and their functions, are meant to be exemplary only, and are not meant to limit implementations of the inventions described and/or claimed in this document.

In accordance with some embodiments, the system 130 may include a processor 102, memory 104, a storage device 106, a high-speed interface 108 connecting to memory 104, and a low-speed interface 112 connecting to low speed bus 114 and storage device 106. Each of the components 102, 104, 106, 108, 111, and 112 are interconnected using various buses, and may be mounted on a common motherboard or in other manners as appropriate. The processor 102 can process instructions for execution within the system 130, including instructions stored in the memory 104 or on the storage device 106 to display graphical information for a GUI on an external input/output device, such as display 116 coupled to a high-speed interface 108. In other implementations, multiple processors and/or multiple buses may be used, as appropriate, along with multiple memories and types of memory. Also, multiple systems, same or similar to system 130 may be connected, with each system providing portions of the necessary operations (e.g., as a server bank, a group of blade servers, or a multi-processor system). In some embodiments, the system 130 may be a server managed by the business. The system 130 may be located at the facility associated with the business or remotely from the facility associated with the business.

The memory 104 stores information within the system 130. In one implementation, the memory 104 is a volatile memory unit or units, such as volatile random access memory (RAM) having a cache area for the temporary storage of information. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

In some embodiments, the system 130 may be configured to access, via the network 110, a number of other computing devices (not shown) in addition to the user input device 140. In this regard, the system 130 may be configured to access one or more storage devices and/or one or more memory devices associated with each of the other computing devices. In this way, the system 130 may implement dynamic allocation and de-allocation of local memory resources among multiple computing devices in a parallel or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, it appears as though the memory is being allocated from a central pool of memory, even though the space is distributed throughout the system. This method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms, as shown in FIG. 1. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1 also illustrates a user input device 140, in accordance with an embodiment of the invention. The user input device 140 includes a processor 152, memory 154, an input/output device such as a display 156, a communication interface 158, and a transceiver 160, among other components. The user input device 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the user input device 140, including instructions stored in the memory 154. The processor may be implemented as a chipset of chips that include separate and multiple analog and digital processors. The processor may be configured to provide, for example, for coordination of the other components of the user input device 140, such as control of user interfaces, applications run by user input device 140, and wireless communication by user input device 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of user input device 140 with other devices. External interface 168 may provide, for example, for wired communication in some implementations, or for wireless communication in other implementations, and multiple interfaces may also be used.

The memory 154 stores information within the user input device 140. The memory 154 can be implemented as one or more of a computer-readable medium or media, a volatile memory unit or units, or a non-volatile memory unit or units. Expansion memory may also be provided and connected to user input device 140 through an expansion interface (not shown), which may include, for example, a SIMM (Single In Line Memory Module) card interface. Such expansion memory may provide extra storage space for user input device 140 or may also store applications or other information therein. In some embodiments, expansion memory may include instructions to carry out or supplement the processes described above and may include secure information also. For example, expansion memory may be provided as a security module for user input device 140 and may be programmed with instructions that permit secure use of user input device 140. In addition, secure applications may be provided via the SIMM cards, along with additional information, such as placing identifying information on the SIMM card in a non-hackable manner. In some embodiments, the user may use the applications to execute processes described with respect to the process flows described herein. Specifically, the application executes the process flows described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the user input device 140 to transmit and/or receive information or commands to and from the system 130 via the network 110. Any communication between the system 130 and the user input device 140 (or any other computing devices) may be subject to an authentication protocol allowing the system 130 to maintain security by permitting only authenticated users (or processes) to access the protected resources of the system 130, which may include servers, databases, applications, and/or any of the components described herein. To this end, the system 130 may require the user (or process) to provide authentication credentials to determine whether the user (or process) is eligible to access the protected resources. Once the authentication credentials are validated and the user (or process) is authenticated, the system 130 may provide the user (or process) with permissioned access to the protected resources. Similarly, the user input device 140 (or any other computing devices) may provide the system 130 with permissioned to access the protected resources of the user input device 130 (or any other computing devices), which may include a GPS device, an image capturing component (e.g., camera), a microphone, a speaker, and/or any of the components described herein.

The user input device 140 may communicate with the system 130 (and one or more other devices) wirelessly through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 160. In addition, short-range communication may occur, such as using a Bluetooth, Wi-Fi, or other such transceiver (not shown). In addition, GPS (Global Positioning System) receiver module 170 may provide additional navigation - and location-related wireless data to user input device 140, which may be used as appropriate by applications running thereon, and in some embodiments, one or more applications operating on the system 130.

The user input device 140 may also communicate audibly using audio codec 162, which may receive spoken information from a user and convert it to usable digital information. Audio codec 162 may likewise generate audible sound for a user, such as through a speaker, e.g., in a handset of user input device 140. Such sound may include sound from voice telephone calls, may include recorded sound (e.g., voice messages, music files, etc.) and may also include sound generated by one or more applications operating on the user input device 140, and in some embodiments, one or more applications operating on the system 130.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a technical environment that includes a back end component (e.g., as a data server), that includes a middleware component (e.g., an application server), that includes a front end component (e.g., a client computer having a graphical user interface or a Web browser through which a user can interact with an implementation of the systems and techniques described here), or any combination of such back end, middleware, or front end components.

As shown in FIG. 1, the components of the system 130 and the user input device 140 are interconnected using the network 110. The network 110, which may be include one or more separate networks, be a form of digital communication network such as a telecommunication network, a local area network (“LAN”), a wide area network (“WAN”), a global area network (“GAN”), the Internet, or any combination of the foregoing. It will also be understood that the network 110 may be secure and/or unsecure and may also include wireless and/or wired and/or optical interconnection technology.

In accordance with an embodiments of the invention, the components of the system environment 100, such as the system 130 and the user input device 140 may have a client-server relationship, where the user input device 130 makes a service request to the system 130, the system 130 accepts the service request, processes the service request, and returns the requested information to the user input device 140, and vice versa. This relationship of client and server typically arises by virtue of computer programs running on the respective computers and having a client-server relationship to each other.

It will be understood that the embodiment of the system environment 100 illustrated in FIG. 1 is exemplary and that other embodiments may vary. As another example, in some embodiments, the system environment may include more, fewer, or different components. As another example, in some embodiments, some or all of the portions of the system environment 100 may be combined into a single portion. Likewise, in some embodiments, some, or all of the portions of the system 130 may be separated into two or more distinct portions.

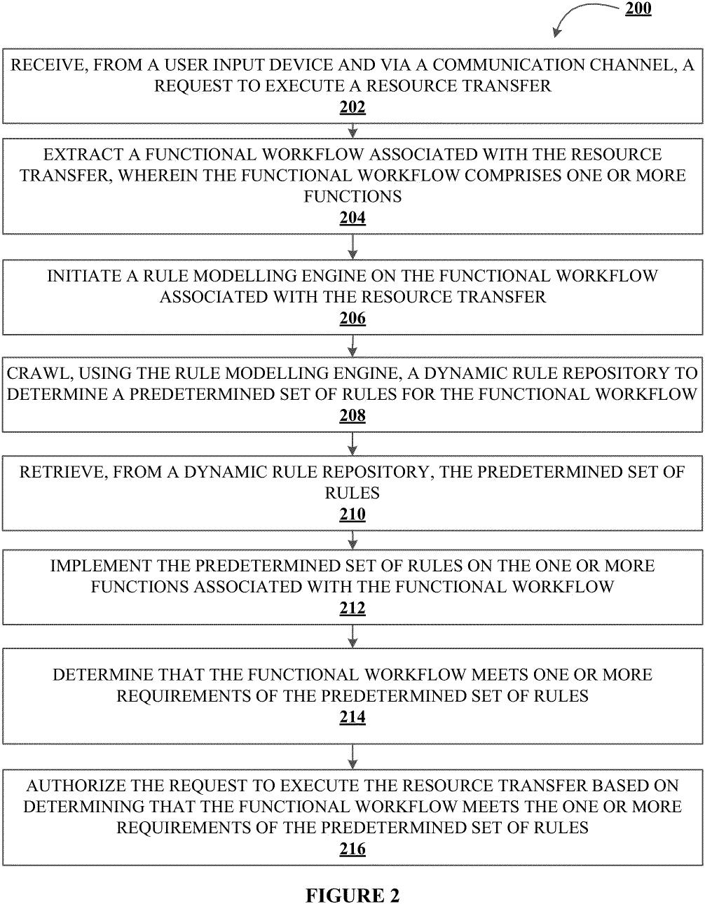

FIG. 2 illustrates a process flow for enhanced exposure detection framework in digital channels 200, in accordance with an embodiment of the invention. As shown in block 202, the process flow includes receiving, from a user input device and via a communication channel, a request to execute a resource transfer. As described herein, a resource transfer may refer to any distribution of resources such as, but not limited to, a payment, processing of funds, purchase of goods or services, a return of goods or services, a payment transaction, a credit transaction, or other interactions involving a user’s resource or account. A user may request and if authorized, subsequently execute resource transfers via various communication channels. As used herein, a communication channel may either refer to a physical transmission medium such as a wire, or to a logical connection over a multiplexed medium such as a radio channel in telecommunications and computer networking. Each communication channel may be used to convey an information signal, for example a digital bit stream, from one or several senders (e.g., user) to one or several receivers (e.g., system 130). To this end, each communication channel may be associated with requisite hardware and/or software components (e.g., user input device 140) that are employed to facilitate the transfer of information.

In some embodiments, in response to receiving the request, the system may be configured to initiate an authentication protocol to determine an authorization level of the user. In this regard, the system may be configured to transmit, via the user input device, an authentication request. In response, the system may be configured to receive, via the user input device, one or more authentication credentials from the user. Based on the authentication credentials, the system may be configured to determine the authorization level of the user. Next, the system may be configured to determine whether the authorization level of the user meets one or more authentication requirements associated with executing the resource transfer. If the authorization level of the user meets one or more authentication requirements, then system may be configured to extract the functional workflow associated with the resource transfer.

Next, as shown in block 204, the process flow includes extracting a functional workflow associated with the resource transfer, wherein the functional workflow comprises one or more functions. In some embodiments, the functional workflow may refer to a structured representation of the functions (activities, actions, processes, operations) associated with the resource transfer that form an orchestrated and repeatable pattern. Each function in the functional workflow may be associated with a type of exposure that is likely to affect that function. Therefore, to determine the authenticity of the resource transfer, each function may need to be individually assessed. To this end, the system may be configured to invoke a rule modelling engine that is capable of identifying an applicable set of rules to be implemented on the functional workflow. The authenticity of the resource transfer may depend on whether each function in the functional workflow meets the requirements associated with the set of rules. Each rule may be associated with a priority level. When implementing the set of rules, the rules with the highest priority level is implemented first followed by the rest of the rules in descending order. In some embodiments, each function may be required to meet the requirements of one or more rules. Each rule for that function is implemented in a descending order of priority level as well.

Next, as shown in block 206, the process flow includes initiating a rule modelling engine on the functional workflow associated with the resource transfer. In some embodiments, the functional workflow for each resource transfer may be unique. However, more often, many resource transfers may share similar (or identical) functional workflows. Functional workflows that are more common may already be associated with a predetermined set of rules that are stored in a dynamic rule repository. Therefore, once a functional workflow associated with the resource transfer is identified, the rule modelling engine may be invoked to determine whether there are any predetermined set of rules for the functional workflow in the dynamic rule repository.

Next, as shown in block 208, the process flow includes crawling, using the rule modelling engine, a dynamic rule repository to determine a predetermined set of rules for the functional workflow. Next, as shown in block 210, the process flow includes retrieving, from a dynamic rule repository, the predetermined set of rules. In some embodiments, the dynamic rule repository may include an organized collection of functional workflows and their corresponding predetermined set of rules. By crawling the dynamic rule repository, the system may be configured to determine a match between the identified functional workflow and the functional workflows stored in the dynamic rule repository. When a match is identified, the system may be configured to retrieve the predetermined set of rules. In some other embodiments, the dynamic rule repository may include an organized collection of functional workflows, a corresponding mapping function, and one or more rules stored therein. Each mapping function may be used to identify a portion of rules of predetermined priority to be assigned to a specific functional workflow. By crawling the dynamic rule repository, the system may be configured to determine a match between the identified functional workflow and the functional workflows stored in the dynamic rule repository. When a match is identified, the system may be configured to retrieve the corresponding mapping function. In response, the system may be configured to use the mapping function to dynamically generate the predetermined set of rules for the functional workflow using the rules stored in the dynamic rule repository.

Next, as shown in block 212, the process flow includes implementing the predetermined set of rules on the one or more functions associated with the functional workflow. As described herein, during implementation, the system may be configured to implement the predetermined set of rules in a decreasing order of priority level.

Next, as shown in block 214, the process flow includes determining that the functional workflow meets one or more requirements of the predetermined set of rules. In some embodiments, the system may be configured to determine whether the functional workflow meets the one or more requirements of the predetermined set of rules in real-time (e.g., during runtime).

In one example, a resource transfer may be susceptible to an Insecure Direct Object Reference (IDOR) exposure. Assume that a user with a User Identification Number (UIN):1234 initiates a login session to retrieve data corresponding to UIN:1234 stored in a file system. The user with UIN:1234 may have to provide the requisite authentication credentials to access the file system. Once authenticated, the user with UIN:1234 may then request data corresponding to UIN:1234. An unauthorized person may intercept this communication between the user and the file system and modify the UIN from UIN:1234 to UIN:5678 before the request is received by the file system. This results in the file system executing the request to retrieve data corresponding to UIN:5678 instead of UIN:1234, which was not authorized for access. Since this switch is triggered by the unauthorized person during runtime, it is imperative that the rule is implemented during runtime as well. First, a hashing function – any function that can be used to map data of arbitrary size to fixed-size values – is applied on the UIN and the data corresponding to each UIN stored in the file system. The resulting hash value is then linked to the static file size and stored in the file system. When the file system retrieves the request for data retrieval, the login session information of the user is parsed to identify the UIN of the user. Here, the user with UIN:1234 originally logged in to request access to data corresponding to UIN:1234. Even though the request was modified enroute to the file system, the login session information of the user remains unchanged. Then, the hashing function is applied on the data being retrieved from the file system, i.e., data corresponding to UIN:5678 and the UIN of the user as retrieved from the login session information to generate a hash value. Since the UIN and the data corresponding to the UIN are have a unique hash value and static file size, if the user who logged into the session is indeed the user who has requested the data from the file system, the hash values must match. This may be an indication that the original request made by the user has not been modified enroute to the file system. And in response, the data corresponding to the UIN may be transmitted to the user. On the other hand, if there is a mismatch between the hash values, it may be an indication of misappropriate activity and is escalated for review. Here, since the UIN from the login session information is UIN:1234 but the data retrieved from the file system is data corresponding to UIN:5678, there will be a mismatch in hash value, causing the rule to fail.

In another example, a resource transfer may be susceptible to an SQL injection exposure. An unauthorized person who has managed to obtain access to the file system may initiate functional requests to retrieve large amounts of data therefrom. To determine whether a particular request is to be satisfied, in addition to authenticating the user, a rule is implemented to determine whether the data fetch request is indeed a valid one. First, statistical methods are implemented to determine a threshold value (or range) for an average amount of data involved in the data fetch requests received by the file system from a single user/functionality. When a new data fetch request is received, the amount of data requested is compared to the threshold value to determine whether the amount of data is less than the threshold value and/or within the acceptable range. If the amount of data requested is indeed less than the threshold value and/or within the acceptable range, the rule is considered passed, and the request is fulfilled. On the other hand, if the amount of data requested is greater than the threshold value and/or is outside the acceptable range, the rule is considered failed, and the issue is escalated to the administrator.

In yet another example, a resource transfer may be susceptible to cross-site scripting exposures. Such exposures occur when unauthorized persons inject unsanctioned scripts into web pages to bypass access controls such as the one-time-payment (OTP) related workflows. To ensure the OTP related workflows are intact, a rule is implemented to determine whether the number of OTPs generated for a session are equal to the number of OTPs validated for that session. In addition, the rule also determines whether an amount of time that has elapsed between OTP generation and OTP validation is within an acceptable range. This rule is implemented for any resource transfers that are associated with the OTP workflow. If the rule passes, the resource transfer is authorized. On the other hand, if the rule fails, the issue is escalated to the administrator.

Next, as shown in block 216, the process flow includes authorizing the request to execute the resource transfer based on determining that the functional workflow meets the one or more requirements of the predetermined set of rules. As described herein, each functional workflow associated with a resource transfer may be associated with a plurality of functions. Each function may be associated with a set of rules that determine the authenticity of that function. For a request transfer to be authorized, each function must meet specific requirements set forth by its corresponding set of rules. In cases where the function does not meet the requirements of its rules, the system may be configured to determine whether this failure is within an acceptable range. The system may then be configured to determine a likelihood of exposure for the resource transfer based on at least functions that have met their requirements, functions that have not met their requirements, but are within an acceptable range, and functions that have not met their requirements with the acceptable range. This likelihood of exposure is compared to a predetermined threshold to determine whether the overall exposure level for the resource transfer is within a tolerance range. If the likelihood of exposure is lesser than the predetermined threshold, the system may be configured to authorize the request to execute the resource transfer. On the other hand, if the likelihood of exposure is greater than the predetermined threshold, it is an indication that the functional workflow does not meet the one or more requirements of the predetermined set of rules. In response, the system may be configured to deny the request to execute the resource transfer based on determining that the.

In some embodiments, in addition to authorizing or deny the resource transfer, the system may be configured to generate a resource transfer authentication event detailing whether the resource transfer meets the requirements of the predetermined set of rules. In response, the system may be configured to record the resource transfer authentication event in an event log.

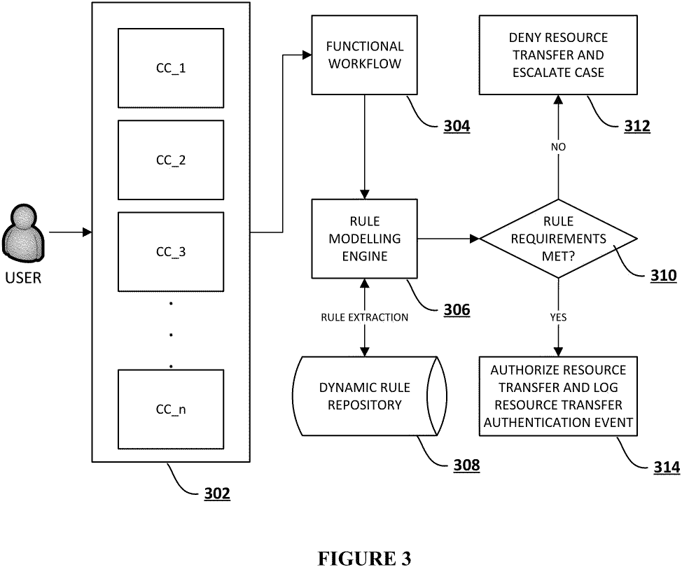

FIG. 3 illustrates a data flow diagram for enhanced exposure detection framework in digital channels 300, in accordance with an embodiment of the invention. As illustrated in FIG. 3, the data flow diagram begins with the user initiating the request to execute the resource transfer via any one of the communication channels CC_1, CC_2, CC_3...CC_n 302. As described herein, first, the authorization level of the user is determined to ensure that the user is indeed authorized to execute the resource transfer. Next, an exposure detection engine is initiated to authenticate, in real-time, the authenticity of the resource transfer in focus. Each resource transfer may have a specific functional workflow, which defines the repeatable pattern of activity for that resource transfer. This functional workflow is extracted at 304 for further analysis. Having extracted the functional workflow, a rule modelling engine 306 is then initiated to identify and retrieve an applicable set of rules from the dynamic rule repository 308 to test the authenticity of the resource transfer. As described herein, each rule may be designed to test specific aspects of each function in the functional workflow. To this end, each rule may be associated with a set of requirements that must be met for a function to be deemed legitimate. At 310, a decision is made whether each function associated with the functional workflow meets the requirements of its corresponding rule. As part of this decision, a likelihood of exposure measure is determined. If the likelihood of exposure is lesser than a predetermined threshold, the resource transfer is authorized, and an authentication event is generated to be recorded 314. On the other hand, if the likelihood of exposure is greater than the predetermined threshold, the resource transfer is denied and the case is escalated to an administrator for further review.

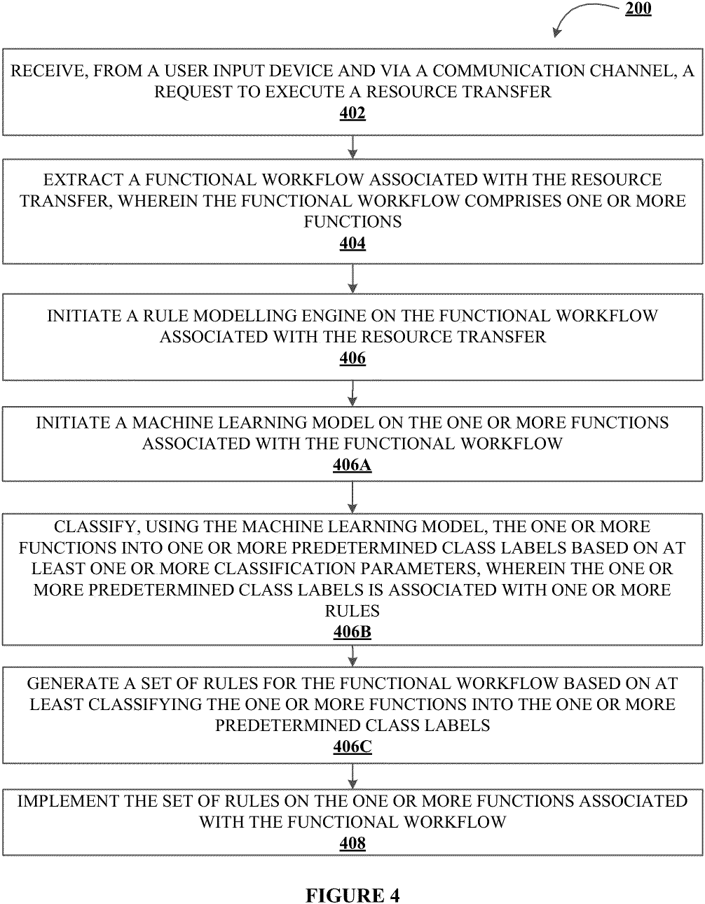

FIG. 4 illustrates a process flow for intelligent rule modelling for exposure detection. As shown in block 402, the process flow includes receiving, from a user input device and via a communication channel, a request to execute a resource transfer.

Next, as shown in block 404, the process flow includes extracting a functional workflow associated with the resource transfer, wherein the functional workflow comprises one or more functions. Typically, each functional workflow may have an applicable set of rules that has been previously generated and stored in the dynamic rule repository. When the exposure detection engine identifies the functional workflow of the resource transfer, it retrieves the corresponding set of rules from the dynamic rule repository for implementation. However, in some cases, the functional workflow may not have an existing set of rules in the dynamic rule repository. In such cases, the system may be configured to dynamically generate, using a rule modelling engine, a set of rules specifically for the functional workflow using machine learning techniques. If the functional workflow is unavailable, the system may access the log files generated by the resource transfer to extract relevant features that may be used to determine its functional workflow.

Next, as shown in block 406, the process flow includes initiating a rule modelling engine on the functional workflow associated with the resource transfer. Next, as shown in block 406A, the process flow includes initiating a machine learning model on the one or more functions associated with the functional workflow. As described herein, the machine learning model may refer to a mathematical model generated by machine learning algorithms based on training data, to make predictions or decisions without being explicitly programmed to do so. In some embodiments, the system may be configured to generate the machine learning model by implementing one or more machine learning algorithms capable of receiving an analyzing input data to predict output values within an acceptable range.

Accordingly, to generate the machine learning model capable of determining a set of functions for the functional workflow, the system may be configured to retrieve existing functional workflows and their corresponding set of rules from the dynamic rule repository. These rules are organized into one or more predetermined class labels. The existing functional workflows and their corresponding set of rules (organized into predetermined class labels) form the training dataset for the machine learning model. In response, the system may be configured to train, using the machine learning algorithm, the machine learning model using the one or more functional workflows and the one or more predetermined set of rules for the one or more functional workflows. Once trained, the system may be configured to determine classification parameters for the machine learning model that are then used to classify unseen functional workflows.

Next, as shown in block 406B, the process flow includes classify, using the machine learning model, the one or more functions into one or more predetermined class labels based on at least one or more classification parameters. By feeding the functional workflow of the resource transfer into the mathematical model, the system may be configured to not only identify applicable rules for testing the functional workflow of the resource transfer, but also identify an order of priority for implementation based on the type of functions involved.

Next, as shown in block 406C, the process flow includes generating a set of rules for the functional workflow based on at least classifying the one or more functions into the one or more predetermined class labels. Next, as shown in block 408, the process flow includes implementing the set of rules on the one or more functions associated with the functional workflow. As described herein, the system may be configured implement the rules in a decreasing order or priority.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

### Incorporation by Reference

To supplement the present disclosure, this application further incorporates entirely by reference the following commonly assigned patent applications:

| | | | |
|---|---|---|---|
| Docket Number | U.S. Patent Application Ser. No. | Title | Filed On |
| 12945US1.014033.4187 | To be assigned | SYSTEM FOR INTELLIGENT RULE MODELLING FOR EXPOSURE DETECTION | Concurrently herewith |

What is claimed is:

1. A system for enhanced exposure detection framework in digital channels, the system comprising:
at least one non-transitory storage device; and
at least one processing device coupled to the at least one non-transitory storage device, wherein the at least one processing device is configured to:
receive, from a user input device and via a communication channel, a request to execute a resource transfer;
extract a functional workflow associated with the resource transfer, wherein the functional workflow comprises one or more functions;
initiate a rule modelling engine on the functional workflow associated with the resource transfer;
crawl, using the rule modelling engine, a dynamic rule repository to determine a predetermined set of rules for the functional workflow;
retrieve, from a dynamic rule repository, the predetermined set of rules;
implement the predetermined set of rules on the one or more functions associated with the functional workflow;
determine that the functional workflow meets one or more requirements of the predetermined set of rules; and
authorize the request to execute the resource transfer based on determining that the functional workflow meets the one or more requirements of the predetermined set of rules.

2. The system of claim 1, wherein the at least one processing device is further configured to:
initiate an authentication protocol to determine an authorization level of the user in response to receiving the request;
determine that the authorization level of the user meets one or more authentication requirements associated with executing the resource transfer; and
extract the functional workflow associated with the resource transfer in response to determining that the authorization level of the user meets the one or more authentication requirements associated with executing the resource transfer.

3. The system of claim 2, wherein initiating the authentication protocol further comprises:
transmitting, via the user input device, an authentication request;
receiving, via the user input device, one or more authentication credentials from the user; and
determining the authorization level of the user based on at least the one or more authentication credentials.

4. The system of claim 1, wherein the at least one processing device is configured to:
retrieve a priority level associated with each rule in the predetermined set of rules; and
implement the predetermined set of rules on the one or more functions associated with the functional workflow in a decreasing order of priority level.

5. The system of claim 1, wherein the at least one processing device is further configured to:
determine that the functional workflow does not meet the one or more requirements of the predetermined set of rules; and
deny the request to execute the resource transfer based on determining that the functional workflow does not meet the one or more requirements of the predetermined set of rules.

6. The system of claim 1, wherein the at least one processing device is further configured to:
determine a likelihood of exposure for the resource transfer based on at least implementing the predetermined set of rules on the one or more functions associated with the functional workflow;
determine whether the likelihood of exposure for the resource transfer is lesser than a predetermined threshold; and
authorize the request to execute the resource transfer based on at least determining that the likelihood of exposure for the resource transfer is lesser than the predetermined threshold.

7. The system of claim 6, wherein the at least one processing device is further configured to:
deny the request to execute the resource transfer based on at least determining that the likelihood of exposure for the resource transfer is greater than the predetermined threshold.

8. The system of claim 1, wherein the at least one processing device is further configured to:
generate a resource transfer authentication event based on at least determining that the functional workflow meets one or more requirements of the predetermined set of rules; and
record the resource transfer authentication event in an event log.

9. A computer program product for enhanced exposure detection framework in digital channels, the computer program product comprising a non-transitory computer-readable medium comprising code causing a first apparatus to:
receive, from a user input device and via a communication channel, a request to execute a resource transfer;
extract a functional workflow associated with the resource transfer, wherein the functional workflow comprises one or more functions;
initiate a rule modelling engine on the functional workflow associated with the resource transfer;
crawl, using the rule modelling engine, a dynamic rule repository to determine a predetermined set of rules for the functional workflow;
retrieve, from a dynamic rule repository, the predetermined set of rules;
implement the predetermined set of rules on the one or more functions associated with the functional workflow;
determine that the functional workflow meets one or more requirements of the predetermined set of rules; and
authorize the request to execute the resource transfer based on determining that the functional workflow meets the one or more requirements of the predetermined set of rules.

10. The computer program product of claim 9, wherein the first apparatus is further configured to:
initiate an authentication protocol to determine an authorization level of the user in response to receiving the request;
determine that the authorization level of the user meets one or more authentication requirements associated with executing the resource transfer; and
extract the functional workflow associated with the resource transfer in response to determining that the authorization level of the user meets the one or more authentication requirements associated with executing the resource transfer.

11. The computer program product of claim 10, wherein initiating the authentication protocol further comprises:
transmitting, via the user input device, an authentication request;
receiving, via the user input device, one or more authentication credentials from the user; and
determining the authorization level of the user based on at least the one or more authentication credentials.

12. The computer program product of claim 9, wherein the first apparatus is configured to:
retrieve a priority level associated with each rule in the predetermined set of rules; and
implement the predetermined set of rules on the one or more functions associated with the functional workflow in a decreasing order of priority level.

13. The computer program product of claim 9, wherein the first apparatus is further configured to:
determine that the functional workflow does not meet the one or more requirements of the predetermined set of rules; and
deny the request to execute the resource transfer based on determining that the functional workflow does not meet the one or more requirements of the predetermined set of rules.

14. The computer program product of claim 9, wherein the first apparatus is further configured to:
determine a likelihood of exposure for the resource transfer based on at least implementing the predetermined set of rules on the one or more functions associated with the functional workflow;
determine whether the likelihood of exposure for the resource transfer is lesser than a predetermined threshold; and
authorize the request to execute the resource transfer based on at least determining that the likelihood of exposure for the resource transfer is lesser than the predetermined threshold.

15. The computer program product of claim 14, wherein the first apparatus is further configured to:
deny the request to execute the resource transfer based on at least determining that the likelihood of exposure for the resource transfer is greater than the predetermined threshold.

16. The computer program product of claim 9, wherein the first apparatus is further configured to:
generate a resource transfer authentication event based on at least determining that the functional workflow meets one or more requirements of the predetermined set of rules; and
record the resource transfer authentication event in an event log.

17. A method for enhanced exposure detection framework in digital channels, the method comprising:
receiving, from a user input device and via a communication channel, a request to execute a resource transfer;
extracting a functional workflow associated with the resource transfer, wherein the functional workflow comprises one or more functions;
initiating a rule modelling engine on the functional workflow associated with the resource transfer;
crawling, using the rule modelling engine, a dynamic rule repository to determine a predetermined set of rules for the functional workflow;
retrieving, from a dynamic rule repository, the predetermined set of rules;
implementing the predetermined set of rules on the one or more functions associated with the functional workflow;
determining that the functional workflow meets one or more requirements of the predetermined set of rules; and
authorizing the request to execute the resource transfer based on determining that the functional workflow meets the one or more requirements of the predetermined set of rules.

18. The method of claim 17, wherein the method further comprises:
initiating an authentication protocol to determine an authorization level of the user in response to receiving the request;
determining that the authorization level of the user meets one or more authentication requirements associated with executing the resource transfer; and
extracting the functional workflow associated with the resource transfer in response to determining that the authorization level of the user meets the one or more authentication requirements associated with executing the resource transfer.

19. The method of claim 18, wherein initiating the authentication protocol further comprises:
transmitting, via the user input device, an authentication request;
receiving, via the user input device, one or more authentication credentials from the user; and
determining the authorization level of the user based on at least the one or more authentication credentials.

20. The method of claim 17, wherein the method further comprises:
retrieving a priority level associated with each rule in the predetermined set of rules; and
implementing the predetermined set of rules on the one or more functions associated with the functional workflow in a decreasing order of priority level.
